(19) United States
(12) Patent Application Publication
(10) Pub. No.: US 2008/0271360 A1
(43) Pub. Date: Nov. 6, 2008

(54) Device for holding fish

(76) Inventor: Troy Barfield, Bainbridge, GA (US)

Correspondence Address: Charles Peeler, PO Box 7, Albany, GA, 31702, US

(21) Appl. No.: 11/998,105

(22) Filed: Nov. 28, 2007

Related U.S. Application Data
(60) Provisional application No. 60/861,614, filed on Nov. 28, 2006.

(51) Int. Cl. A01K 97/18; A01K 97/00

(52) U.S. Cl. 43/53.5; 606/208; 43/4

(57) ABSTRACT

The present invention is a device for holding fish, said device comprising first and second handles attached to first and second arms. The first and second arms are connected in scissor-like fashion. The first and second arms are connected to first and second contact plates. The first and second contact plates pinch the inside and outside of a fish's mouth when the device is in the closed position, thereby allowing a fish to lifted out of the water or off the ground. The present invention may also comprise first and second tongs attached to first and second arms. In this embodiment, the first and second tongs are shaped substantially like semi-ovals and are attached to the first and second contact plates.

### RELATED APPLICATIONS

This application claims priority to provisional patent application No. 60/861,614 entitled “Device for Holding Fish” filed Nov. 28, 2006 in the name of Troy Barfield.

### BACKGROUND OF THE INVENTION

Often times, the most difficult part of fishing is removing the hook from the fish's mouth after reeling it in. More specifically, removing the hook exposes a fisherman to being finned or bitten by the fish and exposes a fisherman to the potential that a hook may implant in the fisherman's fingers or hand. In addition, it is often times desirable to remove the hook from the fish's mouth while causing as little trauma or physical impact to the fish as possible.

In the past, to remove a hook from a fish's mouth, a fisherman had to hold the fish in the fisherman's hand and remove the hook with the fisherman's other hand. More recently, a number of devices have appeared on the market which may be used to hold a fish by the mouth while the hook is being removed. Examples of such fish holding devices include the Boga Grip product, the Berkeley Big Game Lip Grip, and the Rapala Lock 'n Grip. These products, however, are cumbersome to use and are unreliable as a result of the fact that the surface area that comes in contact with the fish's mouth is very small. This causes the fish's mouth to often times slip out of the grip or puncture. What is needed in the art is a fish holding device that can easily be used with one hand and will reliably hold a fish by the inside and outside of its mouth while causing a minimal amount of trauma to the fish or damage to the fish's mouth.

### SUMMARY OF THE INVENTION

The present invention is a device for holding fish as set forth more particularly in the figures accompanying this application wherein like numerals refer to like elements across the various figures. The device of the present invention includes opposing first and second handles. A first arm and second arm connect to the first and second handles, respectively. The first and second arms are connected to one another in an overlapping scissor-like fashion at a connection point. In one embodiment of the invention, first and second contact plates are attached to the first and second arms at the end of the first and second arms opposite the first and second handles.

In one embodiment of the invention, the first and second contact plates are connected to the first and second arms in a static manner such that the contact plates do not move relative to the first and second arms. In another embodiment of the invention, the first and second contact plates are dynamically connected to the first and second arms such that the contact plates are free to swing or hinge relative to the first and second arms.

The invention further comprises a locking mechanism adjacent to each handle wherein the locking mechanism is comprised of a first and second appendage extending towards one another from the first and second handles, respectively.

The device may further comprise opposing ridges located on the opposing arms adjacent to the scissor-like connection point. The opposing ridges fit into one another when the arms are in the closed position. This further stabilizes the device while it is in the closed or locked position.

In another embodiment of the invention, first and second tongs are connected to the first and second arms at a connection point on an end of the first and second arms opposite from the first and second handles. The first and second tongs may be shaped like semi-ovals so as to allow space for the fish's mouth to extend between the first and second tongs while the device is in the open and closed position. In this embodiment, first and second contact plates are connected to first and second tongs. As described above, this connection point may be static, i.e., the first and second contact plates do not move relative to the first and second tongs, or dynamic wherein the first and second contact plates may swing or hinge relative to the first and second tongs.

### DESCRIPTION OF DRAWINGS

FIG. 1 represents the device of the present invention in an open or unlocked configuration wherein first and second contact plates are attached to first and second tongs which are attached to first and second arms.

FIG. 2 represents the device of the present invention in a closed or locked configuration wherein first and second contact plates are attached to first and second tongs which are attached to first and second arms.

FIG. 3 represents the first and second handles, first and second arms, and first and second appendages of a locking mechanism in an unlocked configuration.

FIG. 4 represents a top-down view of a contact plate attached to a tong or arm with a rivet type attachment means that allows the contact plate to swing or hinge relative to the tong or arm.

FIG. 5 represents a side view of a contact plate attached to a tong or arm with a rivet type attachment means that allows the contact plate to swing or hinge relative to the tong or arm.

FIG. 6 represents a bottom-up view of a contact plate for contacting the inside or outside of the mouth of a fish.

FIG. 7 represents a side view of the device of the present invention wherein the contact plates are holding a fish by the inside and outside of its mouth, and the device is in the closed or locked position.

FIG. 8 represents a side view of the interlocking teeth of the locking mechanism in an unlocked position.

FIG. 9 represents a side view of the interlocking teeth of the locking mechanism in a locked position.

FIG. 10 represents the device of the present invention wherein first and second contact plates are attached to first and second arms.

### DETAILED DESCRIPTION OF THE INVENTION

The present invention is a device for holding fish as set forth more particularly in the figures accompanying this application wherein like numerals refer to like elements across the various figures. The device of the present invention includes opposing first and second handles (10 and 20, respectively). A first arm and second arm (30 and 40, respectively) connect to the first (10) and second (20) handles. The first (30) and second (40) arms are connected to one another in an overlapping scissor-like fashion at a connection point (50). In one embodiment of the invention, first and second contact plates (60 and 70, respectively) are attached to the first (30) and second (40) arms at the end of the first and second arms opposite the first (10) and second (20) handles.

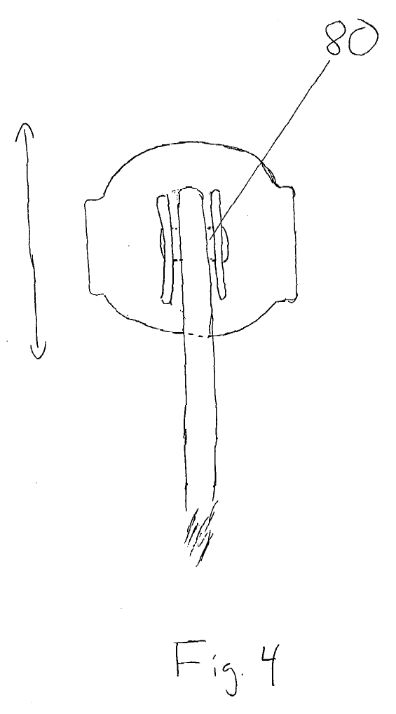

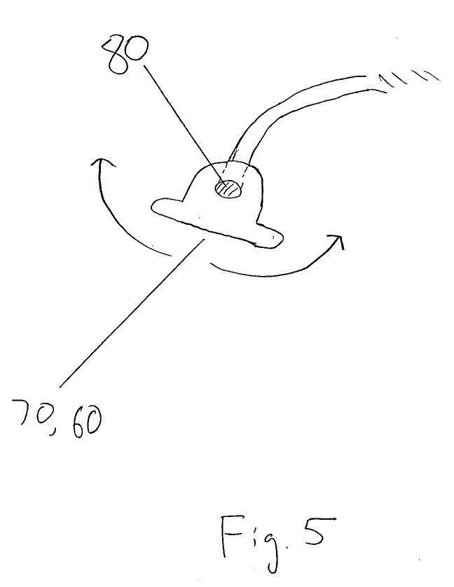

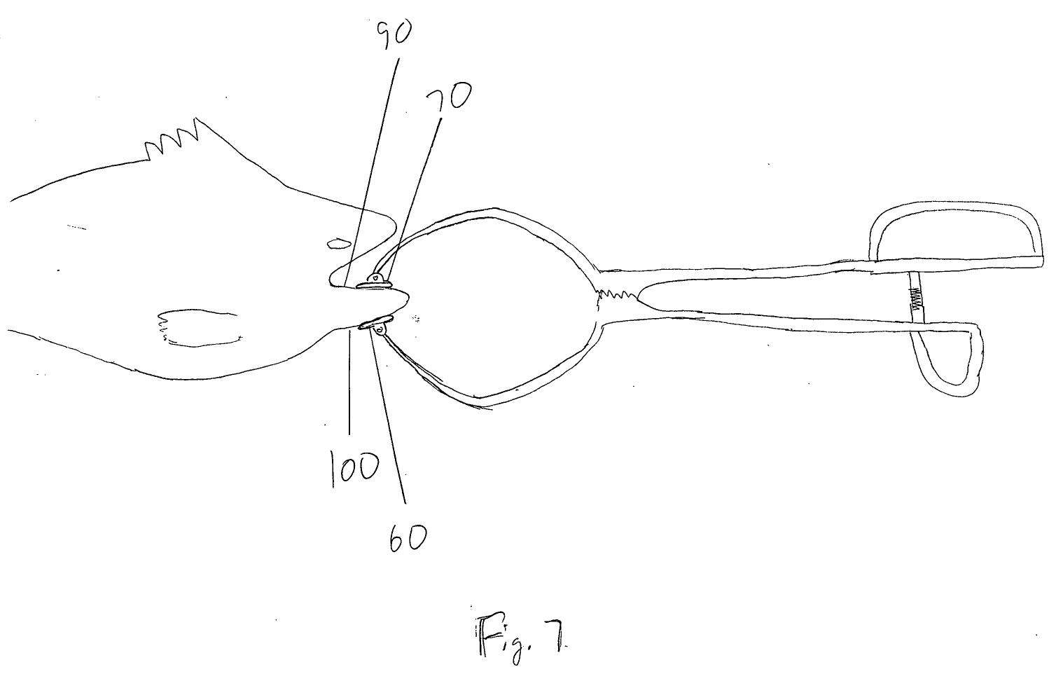

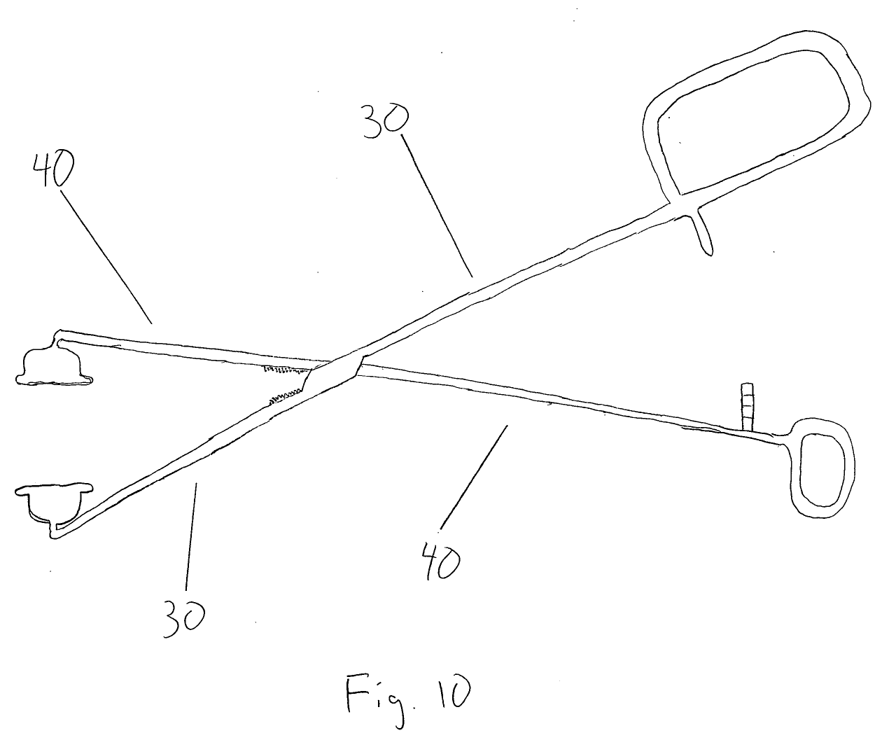

In one embodiment of the invention as set forth in FIG. 10, the first (60) and second (70) contact plates are connected to the first (30) and second (40) arms in a static manner such that the contact plates do not move relative to the first (30) and second (40) arms. In another embodiment of the invention, as set forth in FIGS. 4 and 5, the first and second contact plates are dynamically connected to the first (30) and second (40) arms such that the contact plates (60, 70) are free to swing relative to the first (30) and second (40) arms. The dimensions of the mouths of individual fish vary. This swing connection (80) allows the first (60) and second (70) contact plates to contour somewhat to the size and shape of individual fish's mouths so as to maximize the amount of contact plate surface area that contacts the inside (90) and outside (100) of the fish's mouth (see FIG. 7).

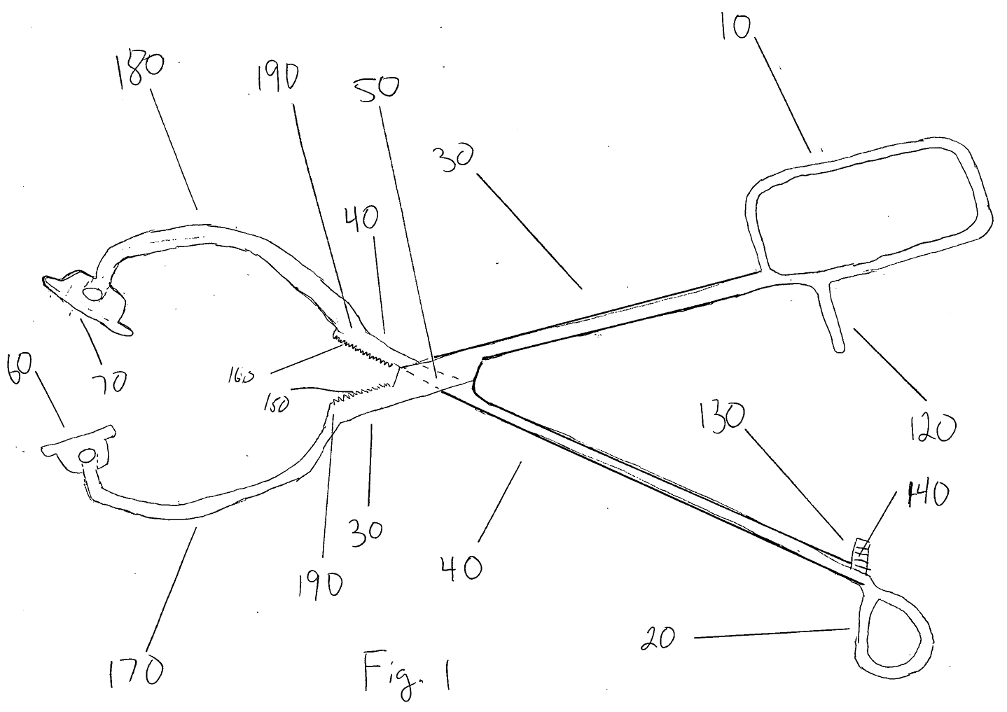

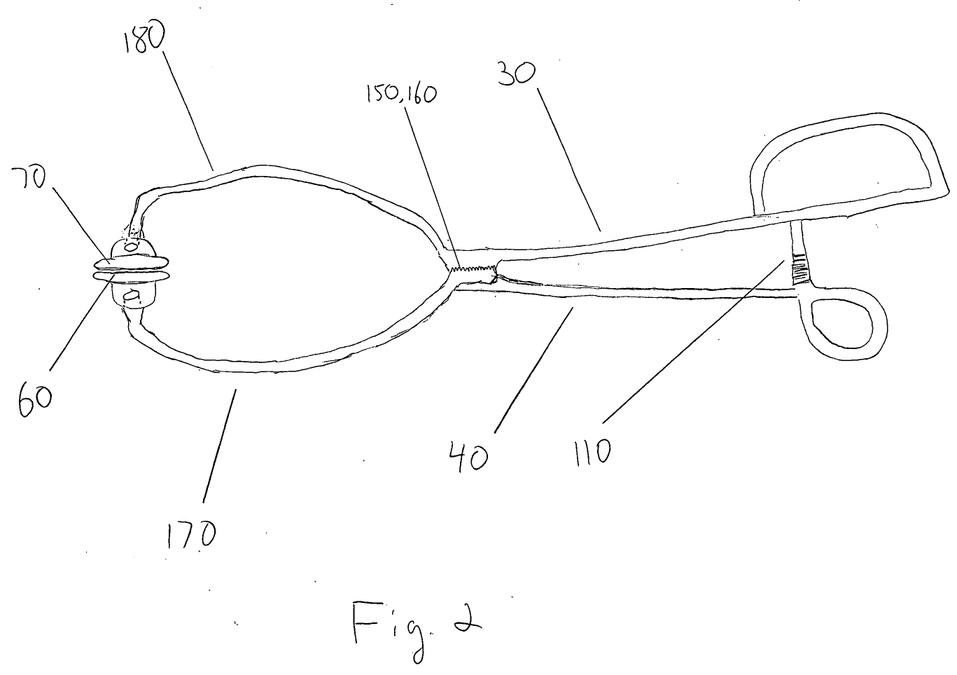

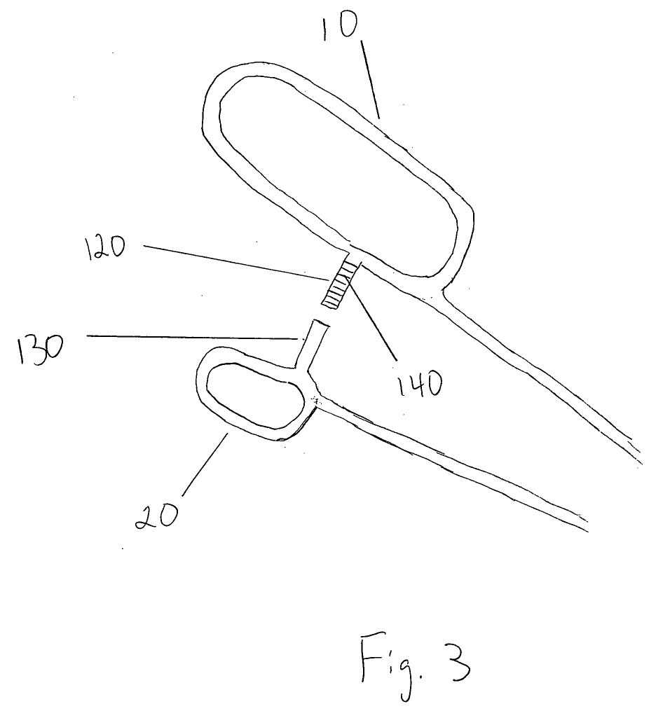

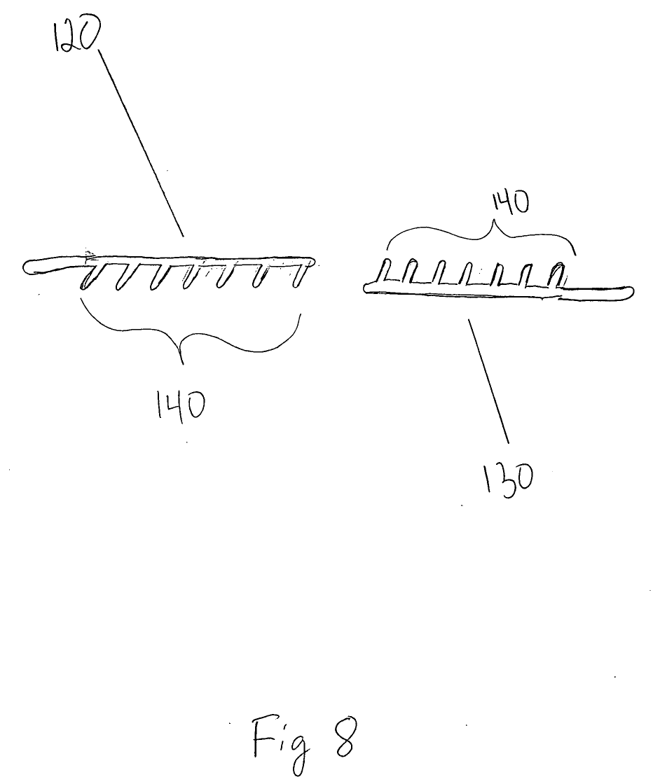

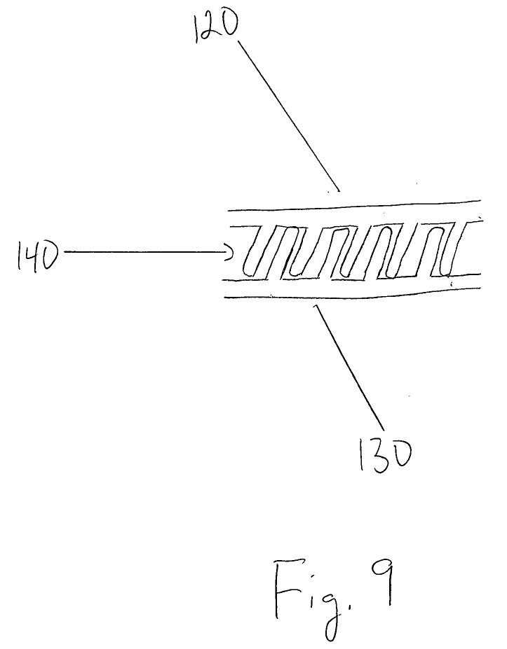

The invention further comprises a first (120) and second (130) appendage extending towards one another from the first (10) and second (20) handles, respectively. At least one face of the first (120) and second (130) appendage contains teeth (140) which when in contact with the teeth of the opposing appendage interlock with each other, as shown in FIGS. 8 and 9. The interlocking of the teeth is facilitated by the angled nature of the teeth, i.e., the teeth of the first appendage (120) are angled towards the first handle (10) and the teeth of the second appendage (130) are angled towards the second handle (20). (FIGS. 8 and 9). In other words the teeth are angled in opposing directions so as to facilitate their interlocking nature. (FIGS. 8 and 9). The device is configured such that when the device is in the closed position, the arms may be slightly bent towards one another such that interlocking teeth exert opposing pressure against one another so as to facilitate the locking nature of the interlocking teeth. This pressure is the result of the slightly bent arms attempting to return to normal resting position. When interlocked, the first (120) and second (130) appendages prevent the first and second arms from moving relative to one another thereby keeping the device in the closed position as depicted in FIGS. 2 and 7. When in the open or unlocked position (FIGS. 1, 3 and 10) the opposing appendages (120) and (130) are not in contact with one another.

The device may further comprise opposing ridges (150 and 160) located on the opposing arms adjacent to the scissor-like connection point (50). The opposing ridges fit into one another when the arms are in the closed position. (See FIGS. 2 and 7). This further stabilizes the device while it is in the closed or locked position.

In another embodiment of the invention, first (170) and second (180) tongs are connected to the first (30) and second (40) arms at connection points (190) on an end of the first (30) and second (40) arms opposite from the first (10) and second (20) handles. One of ordinary skill in the art will understand that the arms and tongs may be formed together from the same piece of metal. As depicted in FIGS. 1 and 7, the first (170) and second (180) tongs may be shaped like semi-ovals so as to allow space for the fish's mouth to extend between the first and second tongs while the device is in the open and closed positions. In this embodiment, first (60) and second (70) contact plates are connected to first (170) and second (180) tongs. As described above, this connection point may be static, i.e. the first and second contact plates do not move relative to the first and second tongs, or dynamic wherein the first and second contact plates may swing or hinge relative to the first and second tongs.

The dimensions of the device of the present invention may vary according to the size of fish a fisherman catches. For example, one size of the present invention consists of a device approximately 12 inches in total length. Such device is useful for holding fish in the approximately less than seven pound range. In this embodiment, the contact plates (60, 70) are approximately ½ inch in diameter; first and second tongs (170, 180) are approximately 2½ inches; the first and second arms (30, 40) are approximately 3 inches; and the first and second handles (10, 20) are approximately 6½ inches. In another embodiment, the total device is approximately 16 inches long. A device of this size is useful for holding fish in the 7 to 12 pound range. In this embodiment, the contact plates (60, 70) are approximately 1 inch in diameter; the tongs (170, 180) are approximately 5 inches; the arms are approximately 7½ inches; and handles approximately 3½ inches. In another embodiment, the device is approximately 20 inches long. This embodiment is useful for holding fish in the 12 to 20 pound range. In this embodiment, the tongs (170, 180) are approximately 7 inches; the arms (30, 40) are approximately 9 inches; and handles (10, 20) approximately 4 inches. The contact plates (60, 70) in this embodiment are approximately 1½ inches in diameter.

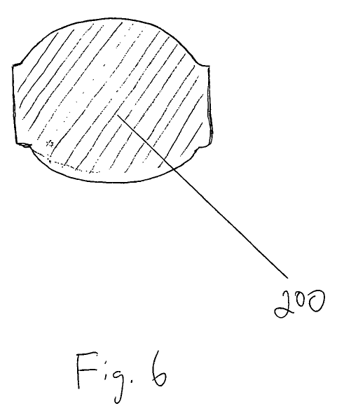

The device operates by opening the device in a scissor-like manner such that the contact plates (60, 70) are far enough apart so as to allow a lip or jaw of a fish's mouth to extend between the opposing contact plates (60, 70). The first (60) and second (70) contact plates have a solid face (FIG. 6, 200) that contacts a fish on the inside (90) and outside (100) of its lip or jaw (see FIG. 7). Once the fish's jaw or lip is extended between the opposing contact plates, the device is closed such that one contact plate is in contact (60) with the outside of the fish's mouth (100) and one contact plate (70) is in contact with the inside of the fish's mouth (90). In other words, the two contact plates pinch the inside and outside of a fish's mouth with sufficient force such that the fish may be held and lifted out of the water or off the ground. When in the closed position, the handles (10, 20) can be locked together allowing the operator to release closing pressure on the handles without releasing the fish (see FIGS. 2, 7 and 9). When it is desired to release the fish, the handles can be unlocked and the device opened. (See FIGS. 1,3, 8 and 10).

The device may be made of any durable material. Preferably the material is resistant to rust, such as stainless steel or tungsten. The handles may be coated in rubber for comfort. The contact plates may likewise be coated in rubber or some other substance to provide additional grip for holding the fish's lip. The contact plates may also be roughed up so as to provide additional grabbing support for the fish's lip. The swing or hinge contact between the tong and the contact plate may be comprised of a rivet allowing the contact plate to move, swing or hinge relative to the arm or tong. Alternatively, the contact plate may be statically affixed to the tong or arm. In that embodiment the contact plate would not move relative to the tong or arm.

1. A device for holding a fish by the mouth comprising:
a first contact plate for contacting the inside of the fish's mouth;
a second contact plate for contacting the outside of the fish's mouth;
a first tong connected to the first contact plate;
a second tong connected to the second contact plate;
a first arm connected to the first tong;
a second arm connected to the second tong;
a scissor-like connection point where the first arm and second arm are connected in scissor-like fashion;
a first handle connected to the first arm;
a second handle connected to the second arm;
a first opposing appendage with interlockable teeth extending from the first handle in a direction towards the second handle; and
a second opposing appendage with interlockable teeth extending from the second handle in a direction toward the first opposing locking mechanism.

2. The device of claim 1, wherein the first and second contact plates are connected to the first and second tongs such that said contact plates can move relative to said tongs.

3. The device of claim 2, wherein the first and second contact plates are in close proximity with one another when the device is in the locked position.

4. The device of claim 2, wherein the first and second contact plates are in contact with one another when the device is in the locked position.

5. The device of claim 2, wherein the first and second tongs are substantially shaped as opposing semi-ovals.

6. The device of claim 1, wherein the first and second contact plates are connected to the first and second tongs such that said contact plates do not move relative to said tongs.

7. The device of claim 1, wherein the first and second arms further comprise opposing ridges adjacent to the scissor-like connection point.

8. A device for holding a fish by the mouth comprising:
a first contact plate for contacting the inside of the fish's mouth;
a second contact plate for contacting the outside of the fish's mouth;
a first arm connected to the first contact plate;
a second arm connected to the second contact plate;
a scissor-like connection point where the first arm and second arm are connected in scissor-like fashion;
a first handle connected to the first arm;
a second handle connected to the second arm;
a first opposing appendage with interlockable teeth extending from the first handle in a direction towards the second handle; and
a second opposing appendage with interlockable teeth extending from the second handle in a direction toward the first opposing locking mechanism.

9. The device of claim 8, wherein the first and second contact plates are connected to the first and second arms such that said contact plates can move relative to said arms.

10. The device of claim 9, wherein the first and second contact plates are in close proximity with one another when the device is in the locked position.

11. The device of claim 9, wherein the first and second contact plates are in contact with one another when the device is in the locked position.

12. The device of claim 8, wherein the first and second contact plates are connected to the first and second arms such that said contact plates do not move relative to said arms.

13. The device of claim 8, wherein the first and second arms further comprise opposing ridges adjacent to the scissor-like connection point.
